(19) United States
(12) Patent Application Publication
(10) Pub. No.: US 2003/0061462 A1
(43) Pub. Date: Mar. 27, 2003

(54) Memory expansion and enhanced system interaction using network-distributed memory mapping

(76) Inventors: James D.M. Fister, Tigard, OR (US); William N. Gallas, Queen Creek, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/967,634

(22) Filed: Sep. 26, 2001

(51) Int. Cl. G06F 13/00

(52) U.S. Cl. 711/206; 711/147

(57) ABSTRACT

A network-distributed memory mapping system for a network. The system includes a memory having a look-up table that provides for memory mapping of network addresses to the memory by enabling redirection of memory requests to the network addresses. The system also includes a network processor to control and execute the memory mapping of the network addresses.

### BACKGROUND

The present invention relates to distributed-memory system. More particularly, the present invention relates to using network-distributed memory mapping to enable expansion of memory space and enhanced interaction of systems.

Transmission Control Protocol/Internet Protocol (TCP/IP) is a widely accepted standard for describing communications over the Internet. In TCP/IP, network communications are divided into several layers, including application, transport, network, data link, and physical layers.

An Internet Protocol (IP) address is assigned to each host system or device operating within this network. The IP address includes a network address portion and a host address portion. The network address portion identifies a network within which the system resides, and the host address portion uniquely identifies the system in that network. The combination of network address and host address is unique, so that no two systems have the same IP address.

In a distributed structure where systems are connected by a communication network such as the Internet described above, downloaded data may be cached in a file on a system. However, this prior art design fails to provide effective means for enabling expansion of system memory and enhanced interaction between systems.

### BRIEF DESCRIPTION OF THE DRAWINGS

FIG. 1 illustrates a network structure configured with a plurality of systems interconnected by a network interface according to an embodiment of the present invention.

FIG. 2 is a block diagram of a network facilitator including a network-distributed memory mapping system in accordance with an embodiment of the present invention.

FIG. 3 is a flowchart describing a process for setting up or configuring a look-up table according to an embodiment of the present invention.

FIG. 4 is a flowchart describing a process for configuring a mapping of the IP address according to an embodiment of the present invention.

FIG. 5 is a flowchart describing a process for accessing the configured memory that is mapped to the IP address space according to an embodiment of the present invention.

FIG. 6 is a block diagram of a processor-based system that may execute codes related to the network memory mapping method described in FIGS. 3 through 5.

### DETAILED DESCRIPTION

In recognition of the above-stated deficiencies with prior designs of a network system, the present invention describes embodiments for using network-distributed memory mapping to enable expansion of memory space and enhanced interaction between systems. The network-distributed memory mapping system enables memory space expansion by memory mapping network address space such as Internet Protocol (IP) addresses into a local system memory design. Moreover, allowing system applications to have access to the memory-mapped network address space enables enhanced interaction between systems. Consequently, for purposes of illustration and not for purposes of limitation, the exemplary embodiments of the invention are described in a manner consistent with such use, though clearly the invention is not so limited.

Present embodiments provide for using a network component attached directly to the memory bus of the processor/chipset that maps network address space such as IP addresses as local memory. Thus, the network component encompasses the concept of mapping network address space such as IP addresses as memory so that the system may treat even remote local area network (LAN) and wide area network (WAN) addresses as local memory addresses. Software implementation of the memory mapping involves local memory look-up table that would redirect memory requests to a network address (e.g. an IP address) on the network. Further, memory mapping of the IP addresses may include capabilities to handle not only 32-bit addressing provided by Internet Protocol Version 4 (IPv4) but also 128-bit addressing provided by Internet Protocol Version 6 (IPv6). Therefore, the memory mapping method of the present embodiments enables mapping of IP addresses assigned to devices as diverse as mobile telephones, other communication devices, and even processors in automobiles.

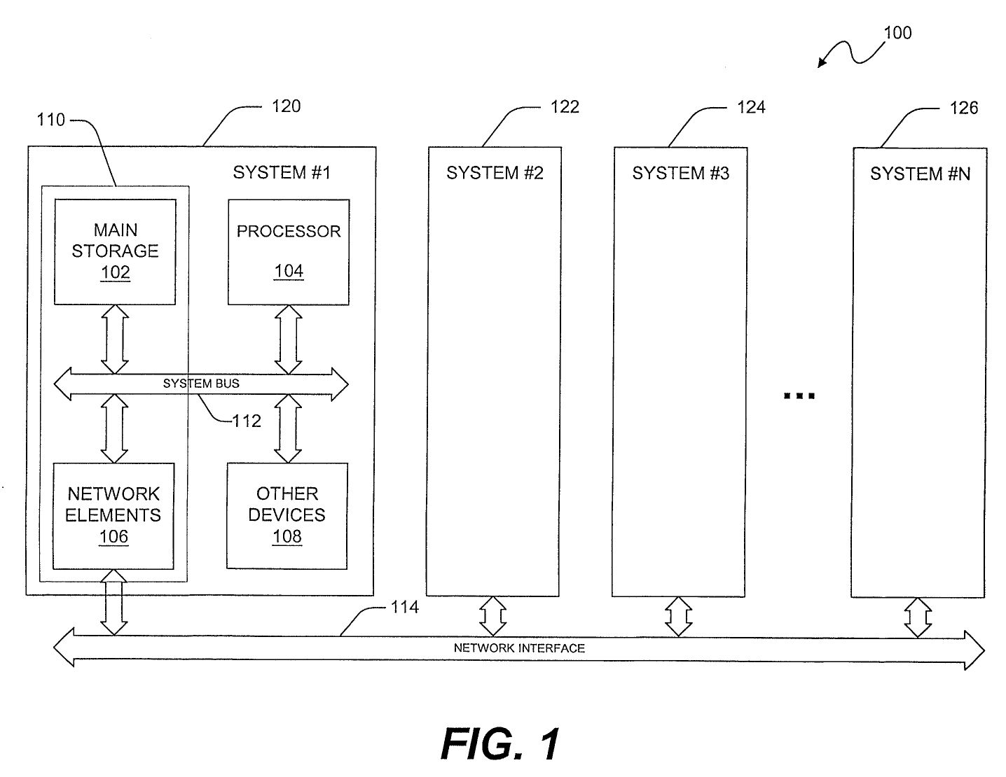

A network structure 100 configured with a plurality of systems 120, 122, 124, 126 interconnected by a network interface 114 according to an embodiment of the present invention is illustrated in FIG. 1. The network interface 114 may include devices, circuits, and protocols that enable data communication between systems 120, 122, 124, 126. For example, the network interface 114 may include modems, fiber optic cables, cable lines, Digital Subscriber Line (DSL), phone lines, Transmission Control Protocol/Internet Protocol (TCP/IP), and other related devices and protocols. In some embodiments, systems 120, 122, 124, 126 may be configured as computer systems. Thus, systems 120, 122, 124, 126 may be substantially similar in configuration and functions. In the illustrated embodiment, the system 120 includes a processor 104 for executing programs, a main storage 102 for storing programs and data during program execution, other devices 108 such as a display monitor or a disk drive, and network elements 106 for controlling data transfer to and from the network interface 114. In one embodiment, the main storage 102 may be configured as a non-volatile memory, and may include programs and look-up tables to enable memory mapping of the network address space. The network elements 106 may include blocks such as a network processor, a network cache, and/or network adapter. The main storage 102 and the network elements 106 may be combined to constitute a network facilitator 110. Each system 120, 122, 124, 126 also includes a system bus 112 used as a data transfer path between blocks 102, 104, 106, 108.

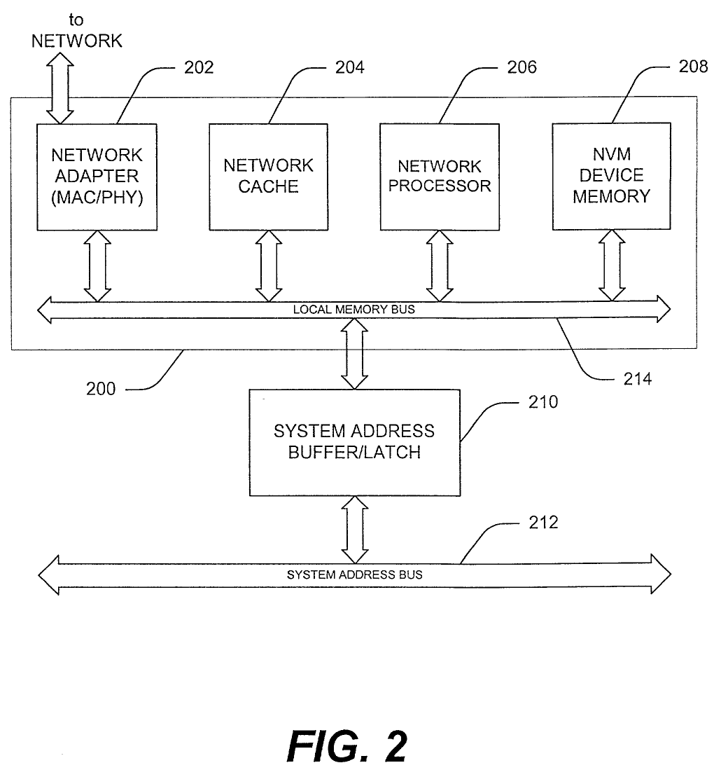

A block diagram of a network facilitator 200 including a network-distributed memory mapping system in accordance with an embodiment of the present invention is shown in FIG. 2. The diagram also includes a system address buffer/latch 210, which interconnects system address bus 212 with the network facilitator 200. In some embodiments, the network facilitator 200 is substantially equivalent to the network facilitator 110 of FIG. 1.

The system address buffer/latch 210 connects to a local memory bus 214 in the network facilitator 200. Moreover, the local memory bus 214 also interconnects blocks 202, 204, 206, 208 in the network facilitator 200. Accordingly, the network facilitator 200 further includes a network adapter 202 such as a media access control/physical layer device (MAC/PHY), a network cache 204, a network processor 206, and a non-volatile device memory (NVM) 208.

In the illustrated embodiment, the network processor 206 provides management of network configuration, data packaging, and network addressing. Furthermore, the network processor 206 controls and executes memory mapping of network address space using a look-up table stored in the non-volatile memory 208. The network cache 204 stores frequently used network data for faster access to a network such as the Internet. The network adapter 202 manages and provides access to the network. In particular, the network MAC/PHY 202 may provide high-speed networking applications including Ethernet switches, backbones, and network convergence. The non-volatile device memory 208 includes programs and a look-up table to enable memory mapping of the IP addresses. The look-up table includes entries whose parameters map IP addresses to the local memory so that a particular application on the system may directly interact with an application or applications of the system at the designated IP address. Hence, interaction between systems becomes transparent to the applications involved. To a particular application, interaction between system applications across a network or networks may operate substantially similar to interaction between different applications in the same system.

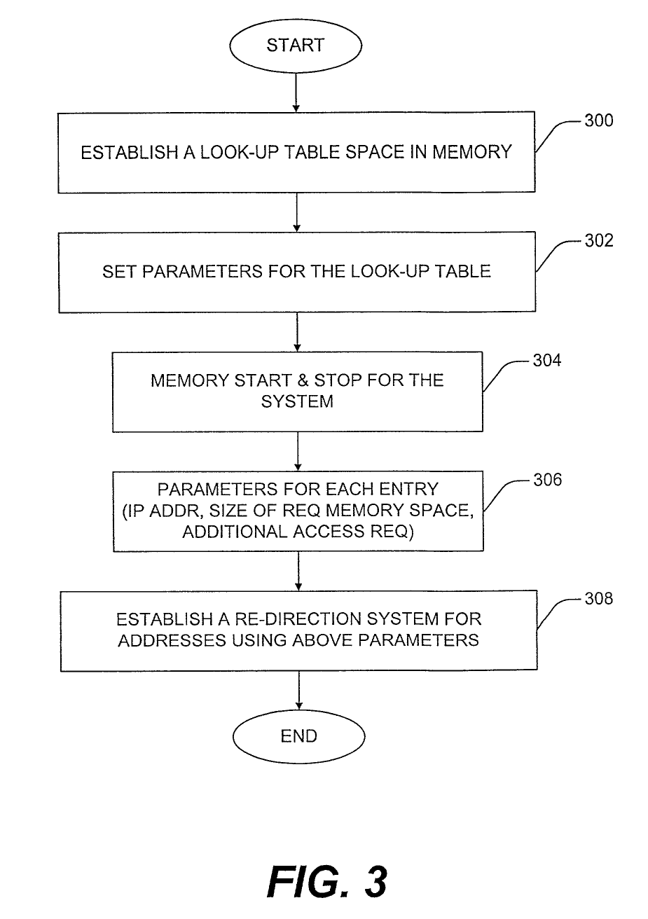

A method for establishing a network distributed-memory to enable expansion of memory space and enhanced interaction between systems according to embodiments of the present invention is illustrated in FIGS. 3 through 5.

FIG. 3 is a flowchart describing a process for setting up or configuring a look-up table according to an embodiment of the present invention. The code for this process may reside in a Basic Input/Output System (BIOS), an operating system (OS), or a middleware, which is a layer of software between the network and the applications. This software may provide services such as identification, authentication, authorization, directories, and security.

In the illustrated embodiment, the configuration process includes establishing a look-up table space in a memory, at 300. This may involve mapping network addresses into the look-up table. In one embodiment, this memory includes a non-volatile device memory 208 described in FIG. 2. Parameters for the look-up table are set at 302. The setting of the parameters may include identifying the start and stop address range of the local memory for the IP-mapped portion, at 304. The parameter setting may also include setting parameters for each entry, such as IP address, size of the required memory space, and additional access requirement (at 306). The size of the required memory space is the amount of device memory being allocated to this particular IP address. A re-direction system is then established (at 308) for addresses using the above-described parameters.

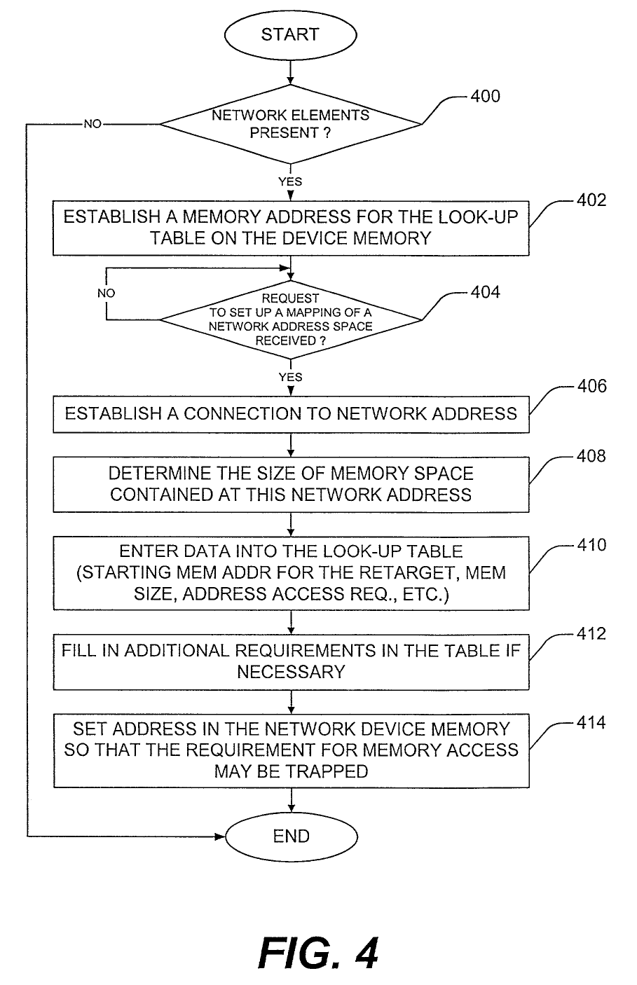

FIG. 4 is a flowchart describing a process for configuring a mapping of the network address space according to an embodiment of the present invention. The code for this process may be programmed into an operating system (OS) or service layer to identify the space where it may be desirable to map the network address space into memory. This may be application independent, but may require OS or network setup.

In the illustrated embodiment, the mapping process includes determining whether network elements are present, at 400. A memory address for the look-up table is established on the device memory, at 402, if the network elements are present. A determination is then made, at 404, as to whether a request to setup a mapping of the network address space has been received. Connection to the network address is established, at 406, when the request is received. The actual size of memory space available at this network address is determined at 408. The data is then entered into the look-up table, at 410. The data may include starting local memory address for the particular network address, the memory size, and address access requirements. Hence, the network address is re-targeted to the local memory at the starting memory address.

Additional requirements in the table are filled, if necessary, at 412. An address in the network device memory is set, at 414, so that the requirement for memory access may be trapped. The memory access trapping may involve the network processor examining each memory access by the system (i.e. examine network address of the access request) and determining whether the processor should act on the access request.

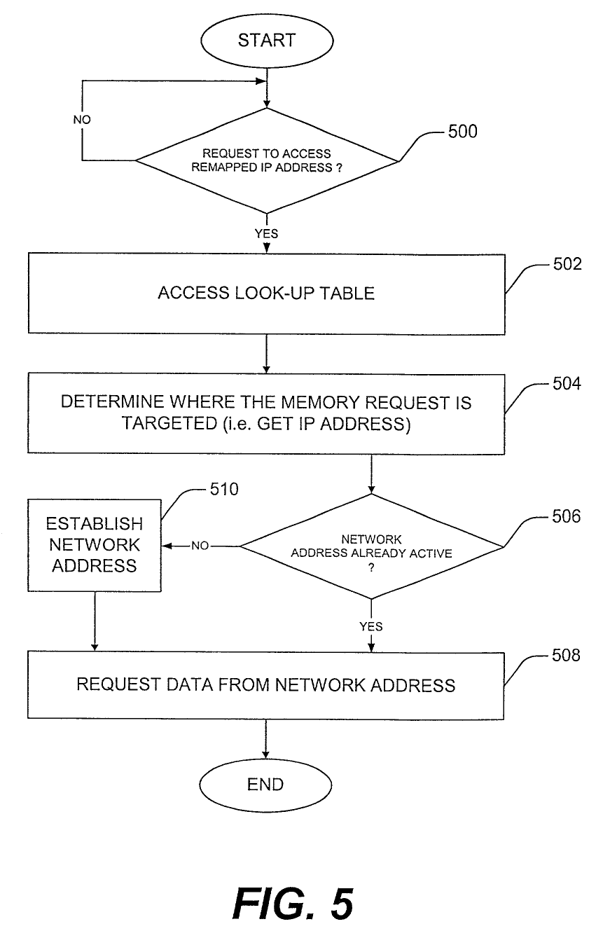

FIG. 5 is a flowchart describing a process for accessing the configured memory that is mapped to the network address space according to an embodiment of the present invention. This process uses the look-up table to access data and/or objects on the Internet from any applications on the system. Thus, this process enables even non-network browser applications to interact and manipulate data/objects residing on systems connected to the network such as the Internet.

In the illustrated embodiment, the access process includes determining whether a request to access the re-mapped network address space has been received, at 500. The look-up table is accessed, at 502, when the request is received. At 504, a determination is made as to where the memory request is targeted. The determination returns a network address. The returned network address is checked, at 506, to determine if that address is active. If the network address is already active, the data is requested from that network address at 508. Otherwise, if the network address is not active, that network address is activated or established at 510.

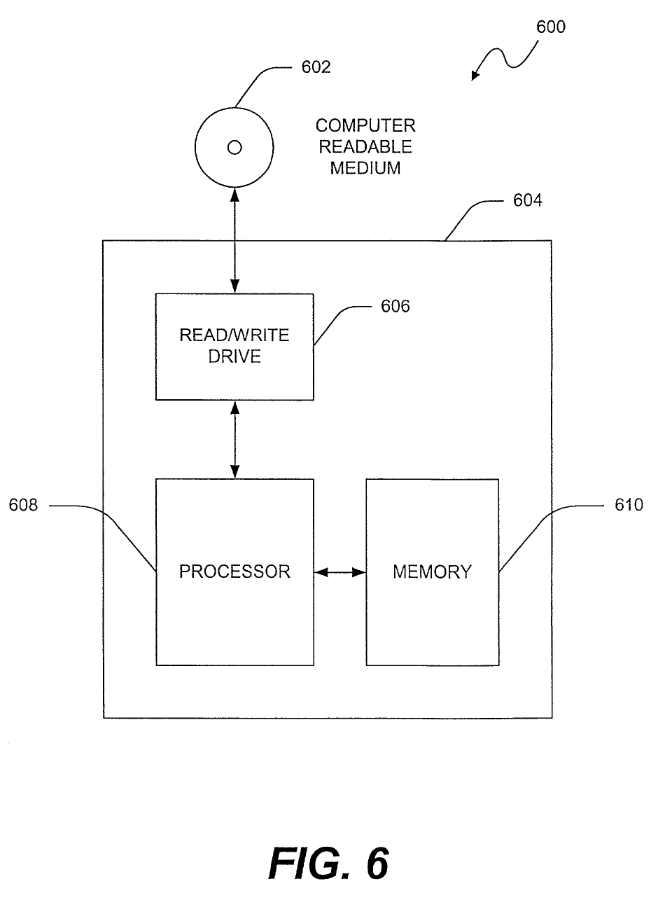

FIG. 6 is a block diagram of a processor-based system 600 which may execute codes residing on the computer readable medium 602. The codes are related to the network memory mapping method described in FIGS. 3 through 5. In one embodiment, the computer readable medium 602 may be a fixed medium such as read-only memory (ROM) or a hard disk. In the case of ROM, the code may reside in BIOS. In the case of hard disk, the code may reside in OS. In another embodiment, the medium 602 may be a removable medium such a floppy disk or a compact disk (CD). A read/write drive 606 in the computer 604 reads the code on the computer readable medium 602. The code is then executed in the processor 608. The processor 608 may access the computer memory 610 to store or retrieve data.

Illustrated embodiments of the system and method for memory mapping network-distributed address space described above, in conjunction with FIGS. 1 through 6, present several advantages. The advantages include the fact that any application may address distributed memory across multiple network locations without having to build a new addressing scheme such as dual (local and remote) addressing scheme. Hence, the illustrated embodiments provide addresses across LAN or WAN to be treated like local memory with substantially all involved aspects of caching, read/write, and other related tasks. This provides advantages to databases operating across multiple computers/systems or those that naturally use a distributed resource scheme to increase the size and complexity of the database. This may also be useful in establishing workgroups that may share files and resources for content creation without a dedicated file sharing mechanism such as a dedicated server. Furthermore, the present embodiments are useful for establishing large memory spaces that may be addressed using 64-bit or higher processors to replace back-office database equipment with a distributed paradigm. However, the present embodiments are equally useful for processors with less than 64-bit capability.

There has been disclosed herein embodiments for using network-distributed memory mapping to enable expansion of memory space and enhanced interaction between systems, which may include computer systems. The disclosure includes network-distributed memory mapping system that enables memory space expansion by memory mapping network address space into a local system memory design using a look-up table. The disclosure also includes a method for establishing a network distributed-memory to enable memory expansion and enhanced interaction between systems. In particular, the method included three processes: a first process for setting up or configuring a look-up table; a second process for configuring a mapping of the network address space; and a third process for accessing the configured memory that is mapped to the network address space.

While specific embodiments of the invention have been illustrated and described, such descriptions have been for purposes of illustration only and not by way of limitation. Accordingly, throughout this detailed description, for the purposes of explanation, numerous specific details were set forth in order to provide a thorough understanding of the present invention. It will be apparent, however, to one skilled in the art that the system and method may be practiced without some of these specific details. For example, although the illustrated embodiments have been described in terms of IP addresses, other network protocol address may be used to map other networks (i.e. other than the Internet). In other instances, well-known structures and functions were not described in elaborate detail in order to avoid obscuring the subject matter of the present invention. Accordingly, the scope and spirit of the invention should be judged in terms of the claims which follow.

What is claimed is:

1. A network-distributed memory mapping system, comprising:
a memory having a look-up table that provides for memory mapping of addresses of a network to said memory by enabling redirection of memory requests to said addresses; and
a network processor to control and execute said memory mapping of said addresses.

2. The system of claim 1, wherein the network is the Internet.

3. The system of claim 2, wherein said network addresses include Internet Protocol (IP) addresses.

4. The system of claim 3, wherein said IP addresses adhere to Internet Protocol Version 6 (IPv6).

5. The system of claim 1, wherein said memory includes a non-volatile memory.

6. The system of claim 1, further comprising:
a network cache to store frequently used network data for faster access to the network.

7. The system of claim 6, further comprising:
a network adapter to manage and provide access to the network.

8. A network structure, comprising:
a network interface; and
a plurality of systems interconnected by said network interface, each system including a network-distributed memory mapping system, where said memory mapping system includes:
a main storage to store programs and data during program execution, said main storage also including a look-up table that provides for memory mapping of network addresses to said main storage by enabling redirection of memory requests to the network addresses,
a processor for executing programs stored in the main storage, and
network elements to control and execute said memory mapping of the network addresses.

9. The system of claim 8, wherein said plurality of systems includes computer systems.

10. The system of claim 8, wherein said network elements include a network adapter.

11. A method for configuring a look-up table, comprising:
establishing the look-up table by mapping network addresses into the look-up table;
setting parameters for the look-up table; and
establishing a redirection system for addresses using said parameters.

12. The method of claim 11, wherein said parameters include a start and stop address range of a memory.

13. The method of claim 11, wherein said parameters include a network address.

14. The method of claim 11, wherein said parameters include a size of required memory.

15. A method for configuring a mapping of network addresses, comprising:
first establishing an address for a look-up table in a memory;
second establishing a connection to a network address;
determining a size of memory space at said network address;
entering data into said look-up table; and
setting an address in the memory so that memory access trapping is enabled.

16. The method of claim 15, further comprising:
determining whether network elements are present, prior to said first establishing.

17. The method of claim 16, further comprising:
determining whether a request to set up a mapping of a network address space is received, prior to said second establishing.

18. The method of claim 15, wherein said data includes starting address for the memory for said network address.

19. The method of claim 15, wherein said data includes address access requirements.

20. The method of claim 15, wherein said memory access trapping includes:
examining network addresses of each memory access request; and
determining whether said each memory access request should be acted upon.

21. A method for accessing network-configured memory, comprising:
accessing a look-up table;
determining a target network address of an access request; and
requesting data from the target network address.

22. The method of claim 21, further comprising:
determining whether a request to access the target network address is received.

23. The method of claim 21, further comprising:
determining whether the target network address is active, prior to said requesting data.

24. A computer readable medium containing executable instructions which, when executed in a processing system, causes the system to perform look-up table configuration, comprising:
establishing the look-up table by mapping network addresses into the look-up table;
setting parameters for the look-up table; and
establishing a redirection system for addresses using said parameters.

25. The medium of claim 24, wherein said parameters include a start and stop address range of a memory.

26. The medium of claim 24, wherein said parameters include a network address.

27. A computer readable medium containing executable instructions which, when executed in a processing system, causes the system to perform mapping of network addresses, comprising:
first establishing an address for a look-up table in a memory;
second establishing a connection to a network address;
determining a size of memory space at said network address;
entering data into said look-up table; and
setting an address in the memory so that memory access trapping is enabled.

28. The medium of claim 27, further comprising:
determining whether network elements are present, prior to said first establishing.

29. The medium of claim 27, further comprising:
determining whether a request to set up a mapping of a network address space is received, prior to said second establishing.

30. A computer readable medium containing executable instructions which, when executed in a processing system, causes the system to perform network-configured memory access, comprising:
accessing a look-up table;
determining a target network address of an access request; and
requesting data from the target network address.

31. The medium of claim 30, further comprising:
determining whether a request to access the target network address is received.

32. The medium of claim 30, further comprising:
determining whether the target network address is active, prior to said requesting data.
